(19) United States
(12) Patent Application Publication
(10) Pub. No.: US 2021/0107211 A1
(43) Pub. Date: Apr. 15, 2021

(54) LIP SUPPORTS USEFUL FOR MAKING OBJECTS BY ADDITIVE MANUFACTURING

(71) Applicant: Carbon, Inc., Redwood City, CA (US)

(72) Inventor: Gregory W. Dachs, II, San Mateo, CA (US)

(21) Appl. No.: 16/496,072

(22) PCT Filed: Mar. 22, 2018
(86) PCT No.: PCT/US2018/023794

§ 371 Date: Sep. 20, 2019

Related U.S. Application Data
(60) Provisional application No. 62/475,496, filed on Mar. 23, 2017.

(51) Int. Cl. B29C 64/124; B29C 64/245

(52) U.S. Cl. CPC B29C 64/124; B33Y 10/00; B29C 64/245

(57) ABSTRACT

A method of making a three-dimensional object includes the steps of: (a) providing a carrier plate (15) and an optically transparent member (12) having a build surface, the carrier plate and the build surface defining a build region therebetween, with the build surface having a polymerizable liquid thereon; and (b) producing an object, e.g., an intermediate object (31b), on the carrier plate by irradiating the build region with light through the optically transparent member and also advancing the carrier plate and the build surface away from one another while maintaining a continuous liquid interface between the carrier plate and the growing intermediate object, wherein: (i) the object includes a carrier plate contact segment, the contact segment including an edge portion; and (ii) the object further comprises a lip support (34b) extending from the contact segment edge portion outward from the contact segment, with the lip support formed on the carrier plate and at least partially surrounding the contact segment.

### RELATED APPLICATIONS

This application claims priority to U.S. Provisional Application No. 62/475,496, filed Mar. 23, 2017, the disclosure of which is hereby incorporated by reference in its entireties.

### FIELD OF THE INVENTION

The present invention concerns additive manufacturing generally, and more specifically concerns methods in which lip supports are added to an object during additive manufacturing to reduce peeling of the object from a carrier plate during additive manufacturing.

### BACKGROUND

In conventional additive or three-dimensional fabrication techniques, construction of a three-dimensional object is performed in a step-wise or layer-by-layer manner. Typically, layer formation is performed through solidification of photo curable resin under the action of visible or UV light irradiation. Generally referred to as “stereolithography,” two particular techniques are known: one in which new layers are formed at the top surface of the growing object; the other in which new layers are formed at the bottom surface of the growing object. Examples of such methods include those given in U.S. Pat. No. 5,236,637 to Hull (see, e.g., FIGS. 3-4), U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al.

Recently, techniques referred to as “continuous liquid interface production” (or “CLIP”) have been developed. These techniques enable the rapid production of three-dimensional objects in a layerless manner, by which the parts may have desirable structural and mechanical properties. See, e.g., J. DeSimone et al., PCT Applications Nos. PCT/US2014/015486 (published as U.S. Pat. No. 9,211,678); PCT/US2014/015506 (published as U.S. Pat. No. 9,205,601), PCT/US2014/015497 (published as U.S. Pat. No. 9,216,546), J. Tumbleston, et al., Continuous liquid interface production of 3D Objects, Science 347, 1349-1352 (published online 16 Mar. 2015), and R. Janusziewcz et al., Layerless fabrication with continuous liquid interface production, Proc. Natl. Acad. Sci. USA 113, 11703-11708 (Oct. 18, 2016).

More recently, dual cure stereolithography resins suitable for stereolithography techniques (particularly for CLIP) are described in J. Rolland et al., U.S. Pat. No. 9,453,142, and US Patent Application Publication Nos. US 2016/0136889, US 2016/0137838 and US 2016/016077. These resins usually include a first polymerizable system typically polymerized by light (sometimes referred to as “Part A”) from which an intermediate object is produced, and also include at least a second polymerizable system (“Part B”) which is usually cured after the intermediate object is first formed, and which impart desirable structural and/or tensile properties to the final object.

These two developments have spurred the application of additive manufacturing processes beyond the manufacture of (primarily) prototype objects, to functional objects more suited to a variety of end uses. This has created a variety of new technical problems requiring solution, for example as discussed below.

### SUMMARY

A method of making a three-dimensional object includes the steps of: (a) providing a carrier plate and an optically transparent member having a build surface, the carrier plate and the build surface defining a build region therebetween, with the build surface having a polymerizable liquid thereon; and (b) producing an object (e.g., an intermediate object) on the carrier plate by irradiating the build region with light through the optically transparent member and also advancing the carrier plate and the build surface away from one another while maintaining a continuous liquid interface between the carrier plate and the growing intermediate object, wherein: (i) the object includes a carrier plate contact segment, the contact segment including an edge portion; and (ii) the object further comprises a lip support extending from the contact segment edge portion outward from the contact segment, with the lip support formed on the carrier plate and at least partially surrounding the contact segment.

In some embodiments, the intermediate object is flexible.

In some embodiments, the lip support is configured to inhibit peeling of the intermediate object from the carrier plate during advancing of the carrier plate away from the build surface.

In some embodiments, the lip support is configured to inhibit peeling of the intermediate object from the carrier plate during intermittent pumping of the carrier plate towards the build surface.

In some embodiments, the average circumference of the object increases at least once over time during the producing step.

In some embodiments, the method further includes the steps of: (c) optionally washing the object (e.g., with a wash liquid comprising an organic solvent); then (d) further curing the intermediate object to produce the three-dimensional object.

The method optionally, but in some embodiments preferably, further includes the step of separating the lip support from the object after the producing step (b).

In some embodiments, the three-dimensional object is elastomeric.

In some embodiments, at least a portion (e.g., at least a major portion) of both the intermediate object and the three-dimensional object is in the configuration of a lattice or mesh.

In some embodiments, the polymerizable liquid comprises a dual cure polymerizable liquid.

In some embodiments, the producing step is at least partially carried out in a reciprocal (or “pumped”) operating mode.

In some embodiments, the producing step (b) comprises a light polymerization step, and/or the further curing step (d) is carried out by heating.

In some embodiments, the optically transparent member is permeable to an inhibitor of polymerization.

In some embodiments, the producing step (b) is carried out by bottom-up stereolithography.

In some embodiments, the producing step (b) is carried out by continuous liquid interface production.

In some embodiments, the polymerizable liquid is comprised of: (i) light-polymerizable monomers and/or prepolymers that can participate in forming an intermediate object by stereolithography (preferably included in an amount of from 5, 10, or 20 percent by weight, to 50, 60, or 80 percent by weight); and (ii) heat-polymerizable monomers and/or prepolymers (preferably included in an amount of from 5, 10 or 20 percent by weight, to 40, 50 or 60 percent by weight).

In some embodiments, the light-polymerizable monomers and/or prepolymers comprise reactive end groups selected from acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

In some embodiments, the polymerizable liquid comprises a light-polymerizable component that degrades after light polymerization thereof in step (a) (e.g., upon heating thereof) and forms a constituent necessary for the further curing step (d).

A further aspect of the invention is a three-dimensional object produced on a carrier plate by additive manufacturing, the object comprising: (a) a three dimensional body portion, the body portion including a carrier plate contact segment, the contact segment including an edge portion; and (b) a lip support connected to and extending from the contact segment edge portion outward from the contact segment, with the lip support formed on the carrier plate and at least partially surrounding the contact segment. Typically, the lip support includes a carrier plate contact segment, and, the body portion carrier plate contact segment and the lip support carrier plate contact segment are co-planar. Typically, the object (when first formed) is adhered to a carrier plate by the lip support and the contact segment (from which the object is subsequently removed).

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 schematically illustrates a method and apparatus for producing a three-dimensional object by continuous liquid interface production (CLIP), where the object is substantially rigid.

FIG. 2 schematically illustrates a method and apparatus for producing a three-dimensional object by CLIP, where the object is flexible.

FIG. 3A is similar to FIG. 2, except that a lip support has been added to the object to reduce the peeling seen in FIG. 2.

FIG. 3B is an enlarged view of a portion of FIG. 3.

FIG. 4 is a further schematic illustration of the production of an object by CLIP with an anti-peel lip, and subsequent removal of that lip.

FIG. 5 is similar to FIG. 4, with an alternate illustrative object.

### DETAILED DESCRIPTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations or one or more of the associated listed items, as well as the lack of combinations when interpreted in the alternative (“or”).

1. Resins and Dual Cure Resins.

While the present invention can be implemented with any suitable polymerizable liquid (particularly light-polymerizable liquids as used in stereolithography), dual cure resins are currently preferred.

Dual cure polymerizable liquids useful in additive manufacturing, particularly for stereolithogrpahy techniques such as continuous liquid interface production (CLIP) are known and described in, for example, J. Rolland et al., PCT Applications PCT/US2015/036893 (see also US Patent Application Pub. No. US 2016/0136889), PCT/US2015/036902 (see also US Patent Application Pub. No. US 2016/0137838), PCT/US2015/036924 (see also US Patent Application Pub. No. US 2016/016077), and PCT/US2015/036946 (see also U.S. Pat. No. 9,453,142). In general, such resins can comprise: (a) light-polymerizable monomers and/or prepolymers that can form an intermediate object (typically in the presence of a photocatalyst); and (b) heat-polymerizable monomers and/or prepolymers. As noted above, in some embodiments, these constituents may be supplemented, and/or replaced with, (c) thermoplastic particles and/or (d) Diels-Alder adducts. Each of these constituents is discussed further below.

A. Light-polymerizable monomers and/or prepolymers. Sometimes also referred to as “Part A” of the resin, these are monomers and/or prepolymers that can be polymerized by exposure to actinic radiation or light. This resin can have a functionality of 2 or higher (though a resin with a functionality of 1 can also be used when the polymer does not dissolve in its monomer). A purpose of Part A is to “lock” the shape of the object being formed or create a scaffold for the one or more additional components (e.g., Part B). Importantly, Part A is present at or above the minimum quantity needed to maintain the shape of the object being formed after the initial solidification during photolithography. In some embodiments, this amount corresponds to less than ten, twenty, or thirty percent by weight of the total resin (polymerizable liquid) composition.

Examples of suitable reactive end groups suitable for Part A constituents, monomers, or prepolymers include, but are not limited to: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

An aspect of the solidification of Part A is that it provides a scaffold in which a second reactive resin component, termed “Part B,” can solidify during a second step, as discussed further below.

B. Heat-polymerizable monomers and/or prepolymers. Sometimes also referred to as “Part B”, these constituents may comprise, consist of or consist essentially of a mix of monomers and/or prepolymers that possess reactive end groups that participate in a second solidification reaction after the Part A solidification reaction. In general, for dual cure resins, examples of methods used to solidify Part B include, but are not limited to, contacting the object or scaffold to heat, water or water vapor, light at a different wavelength than that at which Part A is cured, catalysts, (with or without additional heat), evaporation of a solvent from the polymerizable liquid (e.g., using heat, vacuum, or a combination thereof), microwave irradiation, etc., including combinations thereof. In this case, heat curing of the “Part B” resins is preferred.

Examples of suitable reactive end group pairs suitable for Part B constituents, monomers or prepolymers include, but are not limited to: epoxy/amine, epoxy/hydroxyl, oxetane/amine, oxetane/alcohol, isocyanate*/hydroxyl, Isocyanate*/amine, isocyanate/carboxylic acid, anhydride/amine, amine/carboxylic acid, amine/ester, hydroxyl/carboxylic acid, hydroxyl/acid chloride, amine/acid chloride, vinyl/Si—H (hydrosilylation), Si—Cl/hydroxyl, Si—Cl/amine, hydroxyl/aldehyde, amine/aldehyde, hydroxymethyl or alkoxymethyl amide/alcohol, aminoplast, alkyne/Azide (also known as one embodiment of “Click Chemistry,” along with additional reactions including thiolene, Michael additions, Diels-Alder reactions, nucleophilic substitution reactions, etc.), alkene/Sulfur (polybutadiene vulcanization), alkene/peroxide, alkene/thiol, alkyne/thiol, hydroxyl/halide, isocyanate*/water (polyurethane foams), Si—OH/hydroxyl, Si—OH/water, Si—OH/Si—H (tin catalyzed silicone), Si—OH/Si—OH (tin catalyzed silicone), Perfluorovinyl (coupling to form perfluorocyclobutane), etc., where *Isocyanates include protected isocyanates (e.g. oximes)), diene/dienophiles for Diels-Alder reactions, olefin metathesis polymerization, olefin polymerization using Ziegler-Natta catalysis, ring-opening polymerization (including ring-opening olefin metathesis polymerization, lactams, lactones, Siloxanes, epoxides, cyclic ethers, imines, cyclic acetals, etc.), etc. As will be noted from the above, the “Part B” components generally comprise at least a pair of compounds, reactive with one another (e.g., a polyisocyanate, and a polyamine).

C. Thermoplastic particles. Thermoplastic polymer particles as used herein are those that are not initially soluble in the polymerizable liquid, but can be dispersed in the liquid below the dissolution temperature thereof. “Insoluble” as used herein refers to both completely insoluble polymer particles, and poorly soluble particles which dissolve so slowly that they can be dispersed in the resin without dissolving to such an extent that they cannot be light polymerized as particles in the resin during production of a three dimensional intermediate. Thus, the particles may be initially dispersed rather than dissolved for any reason, including but not limited to inherently immisciblity/insolubility, Upper Critical Solution Temperature (UCST), crystallization, encapsulation in a shell which melts/degrades at high temperatures (e.g., wax melt, crystal melt, hydrogen bonding, degradation at high temperature, etc.).

Optionally, but in some embodiments preferably, the thermoplastic polymer from which the particles are formed may include terminal function or reactive groups. Suitable functional or reactive groups include, but are not limited to, amine, phenol, maleimide, and carboxyl groups. Such reactive groups may be included for any of a variety of purposes, including but not limited to promoting compatibility and adhesion between matrices, such as: the first and second curable components of the dual cure system, and the thermoplastics, may react with thermosettable component or UV curable component to form stable linkages, may react with thermosettable components or UV curable component transiently, to control domain size and morphology of phase-separated thermoplastic, may catalyze cure of thermosettable components, acting as a latent catalyst (especially amine-terminated with epoxy and cyanate ester), etc.

In general, the thermoplastic particles have an average diameter of from 0.5 to 10, 20, or 50 microns. They may be prepared from a thermoplastic polymer by any suitable technique, including but not limited to mechanical grinding, cryo milling, spray drying, coagulation, etc., along with sieving or other techniques known to those skilled in the art.

D. Additional resin ingredients. Photoinitiators included in the polymerizable liquid (resin) can be any suitable photoiniator, including type I and type II photoinitiators and including commonly used UV photoinitiators, examples of which include but are not limited to such as acetophenones (diethoxyacetophenone for example), phosphine oxides diphenyl(2,4,6-trimethylbenzoyl)phosphine oxide, phenylbis(2,4,6-trimethylbenzoyl) phosphine oxide (PPO), Irgacure 369, etc. See, e.g., U.S. Pat. No. 9,453,142 to Rolland et al.

The liquid resin or polymerizable material can have solid particles suspended or dispersed therein. Any suitable solid particle can be used, depending upon the end product being fabricated. The particles can be metallic, organic/polymeric, inorganic, or composites or mixtures thereof. The particles can be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. The particles can be of any suitable size (for example, ranging from 1 nm to 20 um average diameter).

The particles can comprise an active agent or detectable compound as described below, though these may also be provided dissolved solubilized in the liquid resin as also discussed below. For example, magnetic or paramagnetic particles or nanoparticles can be employed.

The liquid resin can have additional ingredients solubilized therein, including pigments, dyes, active compounds or pharmaceutical compounds, detectable compounds (e.g., fluorescent, phosphorescent, radioactive), etc., again depending upon the particular purpose of the product being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

Hardeners: Additional components (hardeners) can be used which react with the liberated maleimide. Any suitable hardener may be used (see, e.g., U.S. Pat. Nos. 5,599,856; 6,656,979; 8,632,654; and 9,3115,698). In some embodiments, the hardener comprises an amine or polyamine (e.g., an aromatic amine or polyamine, a cycloaliphatic amine or polyamine, an aliphatic amine or polyamine such as a polyether amine, etc.).

In some embodiments, the hardener comprises a thiol or polythiol, an allyl or polyallyl (diallyls, triallyls); a maleimide (including but not limited to those described herein above and below); a vinyl ether, etc.

Particular examples of suitable thiol hardeners include, but are not limited to, 4,4′-dimercaptodiphenylether, 4,4′-dimercaptobiphenyl, trimethylolpropane tris(3-mercaptopropionate), pentaerythritol tetrakis(3-mercaptopropionate), 1,3,5-tris(3-mercaptopropyl)-1,3,5-triazine-2,4,6-trione, etc.

Examples of suitable allyls include, but are not limited to, allyl (meth)acrylate, 2,2′-diallylbisphenol A and triallyl-1,3,5-triazine-2,4,6-(1H,3H,5H)-trione.

In some embodiments, the hardener comprises a latent hardener (including mixtures thereof): That is, a hardener having a low reactivity at lower temperatures, and/or which is sparingly soluble at lower temperatures, such that the hardener can be more stable at room temperature, but then activated upon heating. Numerous examples of latent hardeners are known (See, e.g., U.S. Pat. No. 8,779,036; see also U.S. Pat. No. 4,859,761). Particular examples include substituted guanidines and aromatic amines, such as dicyandiamide, benzoguanamine, o-tolylbiguanidine, bis(4-aminophenyl) sulfone (also known as diamino diphenylsulfone: DDS), bis(3-aminophenyl) sulfone, 4,4′-methylenediamine, 1,2- or 1,3- or 1,4-benzenediamines, bis(4-aminophenyl)-1,4-diisopropylbenzene (e.g. EPON 1061 from Shell), bis(4-amino-3,5-dimethylphenyl)-1,4-diisopropylbenzene (e.g. EPON 1062 from Shell), bis(aminophenyl) ether, diaminobenzophenones, 2,6-diaminopyridine, 2,4-toluenediamine, diaminodiphenylpropanes, 1,5-diaminonaphthalene, xylenediamines, 1,1-bis-4-aminophenylcyclohexane, methylenebis(2,6-diethylaniline) (e.g. LONZACURE M-DEA from Lonza), methylenebis(2-isopropyl-6-methylaniline) (e.g. LONZACURE M-MIPA from Lonza), methylenebis(2,6-diisopropylaniline) (e.g. LONZACURE M-DIPA from Lonza), 4-aminodiphenylamine, diethyltoluenediamine, phenyl-4,6-diaminotriazine, and lauryl-4,6-diaminotriazine. Still other examples include N-acylimidazoles such as 1-(2′,4′,6′-trimethylbenzoyl)-2-phenylimidazole or 1-benzoyl-2-isopropylimidazole (see, e.g., U.S. Pat. Nos. 4,436,892 and 4,587,311); Cyanoacetyl compounds such as neopentyl glycol biscyanoacetate, N-isobutylcyanoacetamide, 1,6-hexamethylene biscyanoacetate or 1,4-cyclohexanedimethanol biscyanoacetate (see, e.g., U.S. Pat. No. 4,283,520); N-cyanoacylamide compounds such as N,N′-dicyanoadipic diamide (see, e.g., U.S. Pat. Nos. 4,529,821, 4,550,203, and 4,618,712; acylthiopropylphenols (see, e.g., U.S. Pat. No. 4,694,096) and the urea derivatives such as toluene-2,4-bis(N,N-dimethylcarbamide) (see, e.g., U.S. Pat. No. 3,386,955); and aliphatic or cycloaliphatic diamines and polyamines if they are sufficiently unreactive. An example which may be mentioned here is polyetheramines, e.g. JEFFAMINE 230 and 400. Aliphatic or cycloaliphatic diamines or polyamines whose reactivity has been reduced by steric and/or electronic influencing factors or/and are sparingly soluble or have a high melting point, e.g. JEFFLINK 754 (Huntsman) or CLEARLINK 1000 (Dorf Ketal) can also be used.

Dyes/non-reactive light absorbers. In some embodiments, polymerizable liquids for carrying out the present invention include a non-reactive pigment or dye that absorbs light, particularly UV light. Suitable examples of such light absorbers include, but are not limited to: (i) titanium dioxide (e.g., included in an amount of from 0.05 or 0.1 to 1 or 5 percent by weight), (ii) carbon black (e.g., included in an amount of from 0.05 or 0.1 to 1 or 5 percent by weight), and/or (iii) an organic ultraviolet light absorber such as a hydroxybenzophenone, hydroxyphenylbenzotriazole, oxanilide, benzophenone, thioxanthone, hydroxypenyltriazine, and/or benzotriazole ultraviolet light absorber (e.g., Mayzo BLS1326) (e.g., included in an amount of 0.001 or 0.005 to 1, 2 or 4 percent by weight). Examples of suitable organic ultraviolet light absorbers include, but are not limited to, those described in U.S. Pat. Nos. 3,213,058; 6,916,867; 7,157,586; and 7,695, 643, the disclosures of which are incorporated herein by reference.

Fillers. Any suitable filler may be used in connection with the present invention, depending on the properties desired in the part or object to be made. Thus, fillers may be solid or liquid, organic or inorganic, and may include reactive and non-reactive rubbers: siloxanes, acrylonitrile-butadiene rubbers; reactive and non-reactive thermoplastics (including but not limited to: poly(ether imides), maleimide-styrene terpolymers, polyarylates, polysulfones and polyethersulfones, etc.) inorganic fillers such as silicates (such as talc, clays, silica, mica), glass, carbon nanotubes, graphene, cellulose nanocrystals, etc., including combinations of all of the foregoing. Suitable fillers include tougheners, such as core-shell rubbers, as discussed below.

Tougheners. One or more polymeric and/or inorganic tougheners can be used as a filler in the present invention. See generally US Patent Application Publication No. 20150215430. The toughener may be uniformly distributed in the form of particles in the cured product. The particles could be less than 5 microns (um) in diameter. Such tougheners include, but are not limited to, those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization.

Core-shell rubbers. Core-shell rubbers are particulate materials (particles) having a rubbery core. Such materials are known and described in, for example, US Patent Application Publication No. 20150184039, as well as US Patent Application Publication No. 20150240113, and U.S. Pat. Nos. 6,861,475, 7,625,977, 7,642,316, 8,088,245, and elsewhere. In some embodiments, the core-shell rubber particles are nanoparticles (i.e., having an average particle size of less than 1000 nanometers (nm)). Generally, the average particle size of the core-shell rubber nanoparticles is less than 500 nm, e.g., less than 300 mm, less than 200 nm, less than 100 nm, or even less than 50 nm. Typically, such particles are spherical, so the particle size is the diameter; however, if the particles are not spherical, the particle size is defined as the longest dimension of the particle. Suitable core-shell rubbers include, but are not limited to, those sold by Kaneka Corporation under the designation Kaneka Kane Ace, including the Kaneka Kane Ace 15 and 120 series of products, including Kanaka Kance Ace MX 120, Kaneka Kane Ace MX 153, Kaneka Kane Ace MX 154, Kaneka Kane Ace MX 156, Kaneka Kane Ace MX170, and Kaneka Kane Ace MX 257 and Kaneka Kane Ace MX 120 core-shell rubber dispersions, and mixtures thereof.

In some embodiments, the dual cure resin can be a Carbon, Inc. rigid polyurethane resin (RPU), flexible polyurethane resin (FPU), or elastomeric polyurethane resin (EPU), available from Carbon, Inc., 1089 Mills Way, Redwood City, Calif. 94063 USA.

2. Additive Manufacturing Methods and Apparatus.

The intermediate object is preferably formed from polymerizable resins by additive manufacturing, typically bottom-up additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication Nos. 2013/0292862 to Joyce, and US Patent Application Publication No. 2013/0295212 to Chen et al. Such techniques typically involve projecting light through a window above which a pool of resin (or polymerizable liquid) is carried. A general purpose carrier is typically positioned above the window and above the pool, on which the growing object is produced. In the present invention, the first component functions as the carrier and is at least partially immersed into the pool of resin as described above and below.

In some embodiments of the present invention, the intermediate object is formed by continuous liquid interface production (CLIP). CLIP is known and described in, for example, PCT Applications Nos. PCT/US2014/015486 (published as U.S. Pat. No. 9,211,678 on Dec. 15, 2015); PCT/US2014/015506 (also published as U.S. Pat. No. 9,205,601 on Dec. 8, 2015), PCT/US2014/015497 (also published as U.S. Pat. No. 9,216,546 on Dec. 22, 2015), and in J. Tumbleston, D. Shirvanyants, N. Ermoshkin et al., Continuous liquid interface production of 3D Objects, Science 347, 1349-1352 (published online 16 Mar. 2015). See also R. Janusziewcz et al., Layerless fabrication with continuous liquid interface production, Proc. Nat. Acad. Sci. USA 113, 11703-11708 (Oct. 18, 2016). In some embodiments, CLIP employs features of a bottom-up three dimensional fabrication as described above, but the irradiating and/or said advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially cured form.

In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and potentially obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

In some embodiments, the additive manufacturing apparatus can be a Carbon, Inc. M1 apparatus implementing continuous liquid interface production, available from Carbon, Inc., 1089 Mills Way, Redwood City, Calif. 94063 USA.

3. Additive Manufacturing with Lip Supports.

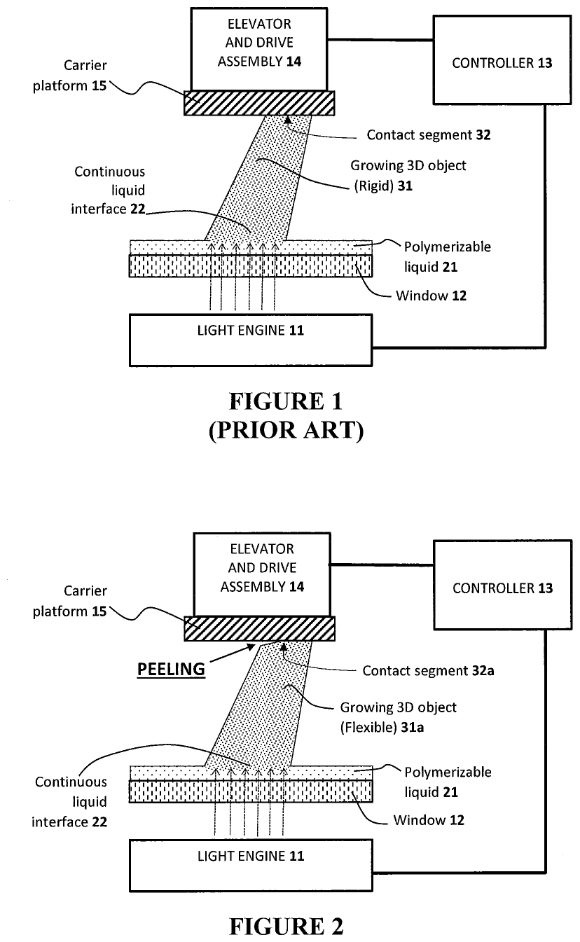

FIG. 1 schematically illustrates a typical method and apparatus for producing a three-dimensional object by continuous liquid interface production (CLIP). The apparatus includes a light engine 11 such as a laser light source operatively associated with a micromirror array, or a scanning laser, which projects through an optically transparent window 12 and into a polymerizable liquid 21. A carrier platform 15 is operatively associated with an elevator and drive assembly 14, which along with the light engine are operatively associated with a controller 13 (in an alternate embodiment, the window and light engine can be lowered away from a stationary carrier platform). The growing 3d object 31 (in this case rigid) is produced by light polymerization of the polymerizable liquid 21 by light projected from light engine 11, with the carrier platform and window being advanced away from one another, and with a contact segment 32 of the 3d object 31 adhered to the carrier platform. In the illustrated embodiment the process is carried out by continuous liquid interface production (described above), so there is a continuous liquid interface 22 maintained between the growing object 31 and the polymerizable liquid 21, for example by maintaining a dead zone of non-polymerized liquid (not shown) between the window and the polymerizable liquid (or electrochemically, or by use of an immiscible liquid, or by other means of carrying out CLIP as noted above).

FIG. 2 schematically illustrates a method and apparatus for producing a three-dimensional object by CLIP, substantially the same as described in FIG. 1, except that the growing 3d object 31a is flexible. Note the peeling that occurs between the contact segment 32a of the object to the carrier platform, causing the formation of a gap. The gap can decrease the efficiency or speed of the production process, and in some cases can cause the production process to fail.

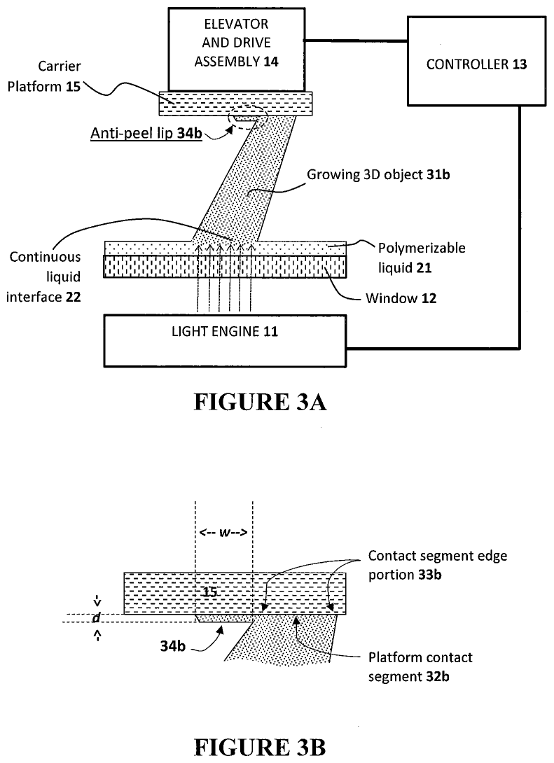

FIGS. 3A-3B are similar to FIG. 2, except that an anti-peel lip support 34b has been added to the object 31b along at least a portion of the contact segment edge portion 33b to reduce the peeling seen in FIG. 2. Note that, in FIG. 2, peeling is more pronounced on the left side of the of the object, where the overhang of the object is greater. Hence on FIG. 3, the lip support is added to the left side of the object. Without wishing to be bound to any particular theory of the invention, it is believed that the suction force between the build plate or “window” and the growing object causes a counter-clockwise moment about the attached face of the part. That being said, in some embodiments (e.g., for a “pumped” or “reciprocal” mode of operation where the growing part is intermittently advanced towards the window to facilitate the flow of resin into the build region), the force of driving the object towards the window can have the opposite effect, so that a lip support on the other (right) side of the object may also have value.

As more clearly seen in the enlarged view of FIG. 3B, the average width dimension (w) of the lip support is generally greater than the average depth dimension (d) of the lip support (e.g., two, three, five or ten times greater, or more), to facilitate removal therefrom from the object after the object has been produced. While the lip support can be inherently frangible or separable from the object due to its relative thinness, score lines, perforations and the like can be included in the lip support immediately adjacent the object's contact segment edge portion 33b, that is, at the point intersected by the right vertical dashed line in FIG. 3B.

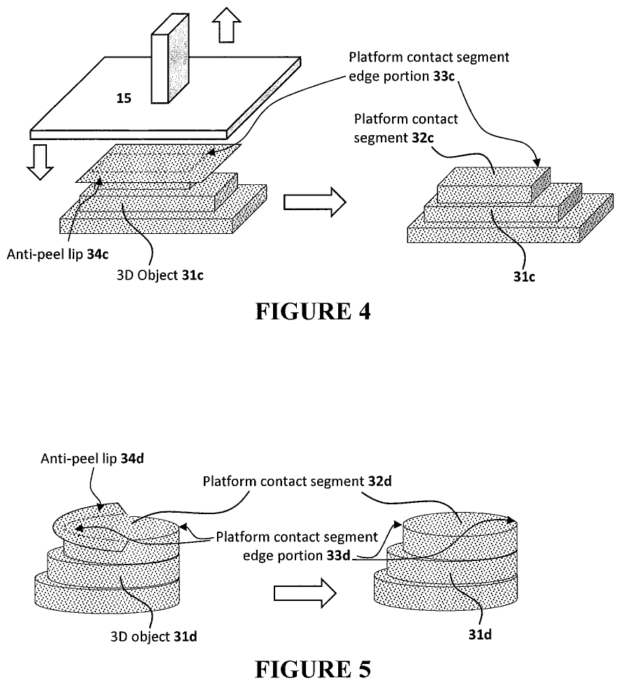

FIG. 4 is a further illustration of the production of an object 31c by CLIP with an anti-peel lip 34c, and subsequent removal of that lip. FIG. 5 is similar to FIG. 4, with an alternate illustrative object 31d, also including an anti-peel lip 34d. In both embodiments, the objects being made are, on average, substantially conical in shape (are frustrums), or tapered in cross-sectional area, with the smaller cross-sectional area immediately adjacent the carrier platform. The lip supports show particular value when the objects being produced increase at least once during production in overall lateral surface area contacting the window as compared to the initial contact (and adhesion) area to the carrier platform to the carrier platform (32c, 32d).

4. Post-Production Steps.

After production by additive manufacturing, the 3d object can be further processed, typically by washing and—in the case where some dual cure resins are employed as the polymerizable liquid—by further curing, such as by heating.

Washing. After the intermediate object is formed, it is optionally washed (e.g., with an organic solvent), optionally dried (e.g., air dried) and/or rinsed (in any sequence).

Solvents (or “wash liquids”) that may be used to carry out the present invention include, but are not limited to, water, organic solvents, and combinations thereof (e.g., combined as co-solvents), optionally containing additional ingredients such as surfactants, chelants (ligands), enzymes, borax, dyes or colorants, fragrances, etc., including combinations thereof. The wash liquid may be in any suitable form, such as a solution, emulsion, dispersion, etc.

Examples of organic solvents that may be used as a wash liquid, or as a constituent of a wash liquid, include, but are not limited to, alcohol, ester, dibasic ester, ketone, acid, aromatic, hydrocarbon, ether, dipolar aprotic, halogenated, and base organic solvents, including combinations thereof. Solvents may be selected based, in part, on their environmental and health impact (see, e.g., GSK Solvent Selection Guide 2009). Additional examples include hydrofluorocarbon solvents (e.g., 1,1,1,2,3,4,4,5,5,5-decafluoropentane (Vertrel® XF, DuPont™ Chemours), 1,1,1,3,3-Pentafluoropropane, 1,1,1,3,3-Pentafluorobutane, etc.); hydrochloro-fluorocarbon solvents (e.g., 3,3-Dichloro-1,1,1,2,2-pentafluoropropane, 1,3-Dichloro-1,1,2,2,3-pentafluoropropane, 1,1-Dichloro-1-fluoroethane, etc.); hydrofluorether solvents (e.g., methyl nonafluorobutyl ether (HFE-7100), methyl nonafluoroisobutyl ether (HFE-7100), ethyl nonafluorobutyl ether (HFE-7200), ethyl nonafluoroisobutyl ether (HFE-7200), 1,1,2,2-tetrafluoroethyl-2,2,2-trifluoroethyl ether, etc.); volatile methylsiloxane solvents (e.g., hexamethyldisiloxane (OS-10, Dow Corning), octamethyltrisiloxane (OS-20, Dow Corning), decamethyltetrasiloxane (OS-30, Dow Corning), etc.), including mixtures thereof.

Any suitable cleaning apparatus may be used, including but not limited to those described in U.S. Pat. Nos. 5,248,456; 5,482,659, 6,660,208; 6,996,245; and 8,529,703.

Further curing. While further (or second) curing may be carried out by any suitable technique, including but not limited to those described in U.S. Pat. No. 9,453,142. In a preferred embodiment, the further curing is carried out by heating.

Heating may be active heating (e.g., in an oven, such as an electric, gas, solar oven or microwave oven, or combination thereof), or passive heating (e.g., at ambient temperature). Active heating will generally be more rapid than passive heating and in some embodiments is preferred, but passive heating—such as simply maintaining the intermediate at ambient temperature for a sufficient time to effect further cure—is in some embodiments preferred.

In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature). In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature).

For example, the intermediate may be heated in a stepwise manner at a first temperature of about 70° C. to about 150° C., and then at a second temperature of about 150° C. to 200 or 250° C., with the duration of each heating depending on the size, shape, and/or thickness of the intermediate. In another embodiment, the intermediate may be cured by a ramped heating schedule, with the temperature ramped from ambient temperature through a temperature of 70 to 150° C., and up to a final (oven) temperature of 250 or 300° C., at a change in heating rate of 0.5° C. per minute, to 5° C. per minute. (See, e.g., U.S. Pat. No. 4,785,075).

Once the further curing step is completed, any routine post-processing steps (further cleaning, cutting, grinding, etc.) can be performed, and the object packaged or assembled with other components for delivery or for its intended use.

The foregoing is illustrative of the present invention, and is not to be construed as limiting thereof. The invention is defined by the following claims, with equivalents of the claims to be included therein.

1. A method of making a three-dimensional object, the method comprising the steps of:
(a) providing a carrier plate and an optically transparent member having a build surface, said carrier plate and said build surface defining a build region therebetween, with said build surface having a polymerizable liquid thereon; and
(b) producing an object on said carrier plate by irradiating said build region with light through said optically transparent member and also advancing said carrier plate and said build surface away from one another while maintaining a continuous liquid interface between said carrier plate and the growing intermediate object, wherein:
(i) said object includes a carrier plate contact segment, said contact segment including an edge portion; and
(ii) said object further comprises a lip support extending from said contact segment edge portion outward from said contact segment, with said lip support formed on said carrier plate and at least partially surrounding said contact segment.

2. The method of claim 1, wherein said intermediate object is flexible.

3. The method of claim 1, wherein said lip support is configured to inhibit peeling of said intermediate object from said carrier plate during advancing of said carrier plate away from said build surface.

4. The method of claim 1, wherein said lip support is configured to inhibit peeling of said intermediate object from said carrier plate during intermittent pumping of said carrier plate towards said build surface.

5. The method of claim 1, wherein the average circumference of said object increases at least once over time during said producing step.

6. The method of claim 1, further comprising the steps of:
(c) optionally washing said object; then
(d) further curing said intermediate object to produce said three-dimensional object.

7. The method of claim 1, further comprising the step of separating said lip support from said object after said producing step (b).

8. The method of claim 1, wherein said three-dimensional object is elastomeric.

9. The method of claim 1, wherein at least a portion of both said intermediate object and said three-dimensional object is in the configuration of a lattice or mesh.

10. The method of claim 1, wherein said polymerizable liquid comprises a dual cure polymerizable liquid.

11. The method of claim 1, wherein said producing step is at least partially carried out in a reciprocal operating mode.

12. The method of claim 1, wherein:
said producing step (b) comprises a light polymerization step, and/or
said further curing step (d) is carried out by heating.

13. The method of claim 1, wherein said optically transparent member is permeable to an inhibitor of polymerization.

14. The method of claim 1, wherein said producing step (b) is carried out by bottom-up stereolithography.

15. The method of claim 1, wherein said producing step (b) is carried out by continuous liquid interface production.

16. The method of claim 1, wherein said polymerizable liquid is comprised of:
(i) light-polymerizable monomers and/or prepolymers that can participate in forming an intermediate object by stereolithography;
(ii) heat-polymerizable monomers and/or prepolymers.

17. The method of claim 16, wherein said light-polymerizable monomers and/or prepolymers comprise reactive end groups selected from acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

18. The method of claim 16, wherein said heat-polymerizable monomers and/or prepolymers comprise reactive end groups selected from: epoxy/amine, epoxy/hydroxyl, oxetane/amine, oxetane/alcohol, isocyanate/hydroxyl, isocyanate/amine, isocyanate/carboxylic acid, cyanate ester, anhydride/amine, amine/carboxylic acid, amine/ester, hydroxyl/carboxylic acid, hydroxyl/acid chloride, amine/acid chloride, vinyl/Si—H, Si—Cl/hydroxyl, Si—Cl/amine, hydroxyl/aldehyde, amine/aldehyde, hydroxymethyl or alkoxymethyl amide/alcohol, aminoplast, alkyne/azide, click chemistry reactive groups, alkene/sulfur, alkene/thiol, alkyne/thiol, hydroxyl/halide, isocyanate/water, Si—OH/hydroxyl, Si—OH/water, Si—OH/Si—H, Si—OH/Si—OH, perfluorovinyl, diene/dienophiles, olefin metathesis polymerization groups, olefin polymerization groups for Ziegler-Natta catalysis, and ring-opening polymerization groups, and mixtures thereof.

19. The method of claim 1, wherein said polymerizable liquid comprises a light-polymerizable component that degrades after light polymerization thereof in step (a) and forms a constituent necessary for said further curing step (d).

20. A three-dimensional object produced on a carrier plate by additive manufacturing, comprising:
(a) a three dimensional body portion, said body portion including a carrier plate contact segment, said contact segment including an edge portion;
(b) a lip support connected to and extending from said contact segment edge portion outward from said contact segment, with said lip support formed on said carrier plate and at least partially surrounding said contact segment.

21. The object of claim 20, wherein said lip support includes a carrier plate contact segment.

22. The object of claim 21, wherein said body portion carrier plate contact segment and said lip support carrier plate contact segment are co-planar.

23. The object of claim 20, wherein said object is adhered to a carrier plate by said lip support and said contact segment.
